(19) United States
(12) Patent Application Publication
(10) Pub. No.: US 2007/0159744 A1
(43) Pub. Date: Jul. 12, 2007

(54) High voltage pin for low voltage process

(76) Inventors: Ramen Dutta, Bangalore (IN); Chih-Jiann Chen, Saratoga, CA (US); Dan Ion Hariton, Pinole, CA (US); Jayanta Kumar Lahiri, Bangalore (IN); May Florence Vijay, Bangalore (IN); Mark Sherwood, Santa Clara, CA (US)

Correspondence Address: Harris Zimmerman;Law Offices of Harris Zimmerman, Suite 710, 1330 Broadway, Oakland, CA, 94612, US

(21) Appl. No.: 11/326,768

(22) Filed: Jan. 6, 2006

(51) Int. Cl. H02H 9/00

(52) U.S. Cl. 361/56

(57) ABSTRACT

An integrated circuit is adapted for dual use in three different ways: 1) it is powered by either of two different low or high voltage sources; 2) it may be connected to the IC package voltage reference pin in two different ways, using either an on-chip internal resistor or an in-package external resistor to limit the voltage/current to the IC; 3) the ESD structures are used not only for their well-known circuit protection function, but also as a conductive path for the high voltage operating source.

### CROSS-REFERENCE TO RELATED APPLICATIONS

Not applicable.

### FEDERALLY SPONSORED RESEARCH

Not applicable.

### SEQUENCE LISTING, ETC ON CD

Not applicable.

### BACKGROUND OF THE INVENTION

1. Field of the Invention

This invention relates to integrated circuit construction and, more particularly, to the provision of a high voltage supply to a low voltage IC.

2. Description of Related Art

In integrated circuit construction a typical practice is to create a silicon die that embodies the desired circuitry, and to include a power supply buss on the die that provides a uniform supply voltage for the circuitry. The typical supply voltage (e.g., V_{DD}) is typically no more than 2.5 VDC. Supply voltage that exceeds this level may likely cause either immediate circuit failure or long-term reliability problems, due to thermal problems, stress on delicate junctions or gates, and the like.

It is also a common practice to provide on-chip ESD diode protection for the circuitry by connecting at least one diode between an internally generated V_{ref} and ground. The V_{ref} and V_{DD} connections have separate pinouts on the IC package. Typically the ESD structure is powered only when an overvoltage (i.e., surge) or ground fluctuation situation occurs.

It has been found that in some situations it may be desirable to drive an IC using a high voltage supply signal. This may be needed for testing purposes, as a substitute for, or in addition to, the typical low voltage supply, to signal the switch from external to internally generated reference voltages, or for some voltage sequencing purposes to other IC components. Silicon IC designs typically do not provide any means or structure for enabling the use of dual voltage supplies, one of them being significantly higher than the designed operating limit of the IC.

### BRIEF SUMMARY OF THE INVENTION

The present invention generally comprises an IC design, or a modification to an existing IC design, that enables the use of a high voltage input to a given pin on a low voltage IC chip, in addition to the typical V_{DD} low voltage power arrangement, without destruction or impact on reliability or functionality. In describing the invention it is assumed that an IC silicon die is mounted in an IC composite or hybrid or normal package (cavity) and connected to the package pin connectors through wire bonding or the like. Also, the composite or hybrid or normal IC includes a typical ESD structure connected between the V_{ref} pin out and ground.

In one aspect of the invention the Vref input pin to the IC circuit may be utilized as directing the IC circuit to look for an internally generated Vref voltage. This may or may not supply power to the IC circuit through this Vref pin. Thus the Vref input pin has a dual aspect, i.e. of voltage level feed and of functional redirection. The Vref pin on the IC circuit normally acts as threshold for input clock signals (differential or single ended signals) such that clock transitions are detected. Detection of clock transitions allows switching of internal registers (at the crossing of the internal (or external) Vref level).

In another aspect of the invention, a single internal or external impedance component is placed in series with the V_{ref} pin of the IC to serve as a voltage/current/power drop element to attenuate the high voltage power signal to a level suitable for powering the IC. This impedance may be switched in or out of the circuit. This impedance limits the current sourced/sunk by the IC at/from the pin that receives the high voltage power signal.

In a further aspect of the invention, the ESD structure serves a dual function: while providing protection to the IC, it also is used to produce a reliable ON voltage clamp to operate the composite IC. Note that in normal composite IC operations all ESD diodes are off; in this invention the ESD diode is intentionally turned on and used as part of the power input circuit for the high voltage powering regime.

In another aspect, the invention provides an IC layout that may be easily adapted for operation by a low or high voltage power source. The IC layout makes use of the ESD features of the circuit, and one option adds an on-silicon series component between the Vref2 pad and the Vref internal circuit. The other option adds an in-package series component between the Vref1 silicon pad and the Vref package pin. If the IC is fabricated using a single-gate (low-voltage only) poly process, the external resistor is added in the IC package cavity, between the Vref1 silicon pad and the IC package reference voltage pin. Alternatively, the IC may be fabricated using a dual-poly gate process (low and high voltage), and either the internal on-silicon series component or the external in-package component may be employed, by selecting the appropriate Vref1 or Vref2 silicon die pad and bonding it to the IC package reference voltage pin. Thus the dual voltage IC may make use of and be adapted to different fabrication processes. Even in the case of single-gate (low-voltage only) poly process, an internal on-silicon resistor may be used if the high-voltage ESD protection is functional.

### BRIEF DESCRIPTION OF THE DRAWING

FIG. 1 is a schematic block diagram of the reference voltage arrangement of the invention for a generalized integrated circuit.

FIG. 2 is a schematic block diagram of the reference voltage arrangement of the invention embodied on a silicon die.

FIG. 3 is a schematic block diagram of the silicon die of FIG. 2 in a first mounting arrangement in an IC package cavity.

FIG. 4 is a schematic block diagram of the silicon die of FIG. 2 in a second mounting arrangement in an IC package cavity.

### DETAILED DESCRIPTION OF THE INVENTION

The present invention generally comprises a integrated circuit arrangement that is designed to permit the circuit to be powered by a standard reference supply voltage, or to be driven by a significantly higher voltage.

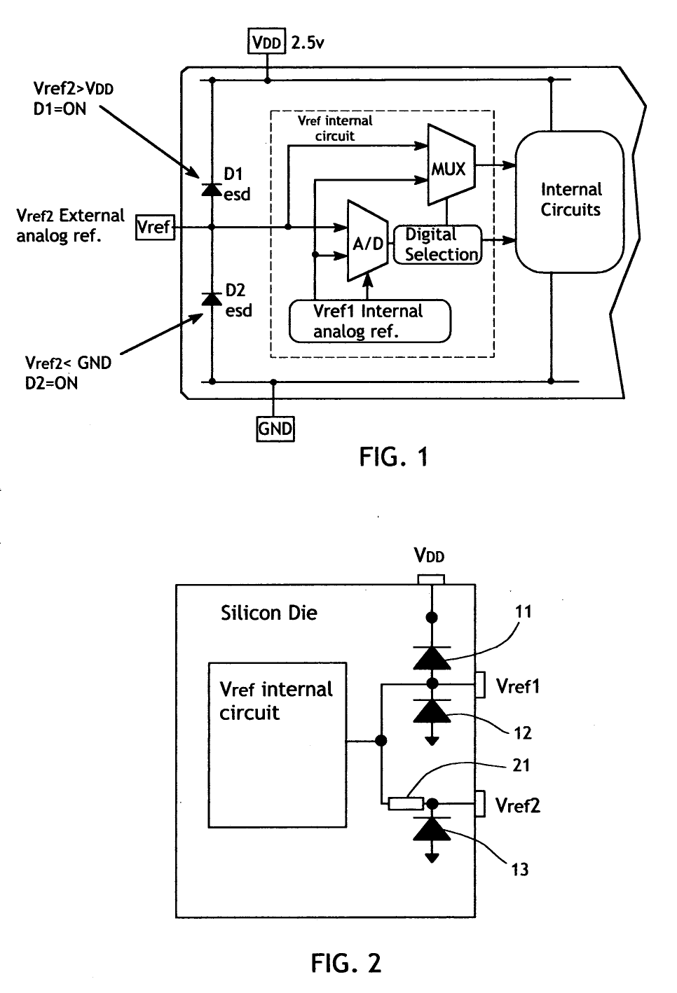

FIG. 1 depicts a general case of the invention, in which the generalized internal circuitry of an IC is connected between a power bus supplied by V_{DD} and ground. A Vref pin is connected through diode D1 to the power bus, and through diode D2 to ground. Diodes D1 and D2 are typically provided as ESD protection for the internal circuitry. Vref is also connected to a MUX circuit which also receives a Vref1 internal analog reference voltage, and the output of the MUX is connected to the internal circuitry. Note that V_{DD}>Vref1>GND. The Vref pin is also connected as an input to A/D converter, as is the Vref1. The output of the A/D converter is connected through a digital selection circuit to the internal circuitry.

The Vref signal is detected by the A/D converter. The digital selection block provides selection information to the analog multiplexer (MUX) so that either the Vref1 or Vref2 power signals are selected and routed to the internal circuitry. The internal circuitry can withstand a voltage input logic level HIGH equal to V_{DD}+V_{diode} (when D1=ON), as well as a voltage input logic level LOW equal to GND−V_{diode} (when D2=ON).

If the signal Vref2 is not present at the Vref pin, the circuit detects its absence and selects the internal Vref1 signal. When the Vref2 signal is present, the Vref2 signal exceeds V_{DD} and GND, and Vref2 will turn on one of the ESD diodes D1 or D2 in direct conduction. In particular, if Vref2 is greater than V_{DD}, then D1 will turn ON. If Vref2 is less than GND, then D2 will turn ON. The turning ON of D1 or D2 will not have any adverse effects on the functional performance of the internal circuitry; that is, the internal circuitry will function normally when either one of the diodes is turned on. Likewise, there will be no functional conflicts between the V_{DD} power flow to the internal circuitry and the power flow through the D1 ESD diode when Vref2<GND.

Thus whichever power supply is powered ON first will power the IC without affecting its function and without compromising the short term or long term reliability of the IC. Thus the IC is enabled to perform its designed functions upon being powered by either the internal supply voltage or a multitude of external supply voltages, while requiring only one Vref pin on the IC package.

With regard to FIG. 2, the invention may be embodied on a silicon die in which the Vref internal circuit (MUX, A/D, digital selection, and internal analog ref.) of FIG. 1 is fabricated, and the input thereto is connected to a Vref1 contact pad. The input is also connected to Vref2 contact pad, and a resistor 21 is placed between the input and Vref2 contact pad. Resistor 21 may be an on-chip integrated in-silicon resistor. The ESD circuit protection described above is embodied as diodes 11 and 12, wherein diode 11 is connected between supply V_{DD} and Vref1, and diode 12 is connected between Vref1 and ground. Both diodes 11 and 12 may be conventional low voltage, single-MOS transistor structures, diode 11 being formed by PMOS and diode 12 by NMOS transistors. In addition, diode 13 is connected between contact pad Vref2 and ground. Diode 13 may comprise a dual gate, high voltage, composite multi-MOS transistor structure.

This die is designed for dual function, wherein either the internal, on-silicon resistor 21 may be used (in which case Vref2 pad is bonded to a contact pin), or an external resistor may be connected in series with Vref1, in which case the external resistor is bonded to contact pin Vref1. Whichever contact pad Vref1 or Vref2 is bonded to a contact pin of the IC package, the other pad is left to float. In either case the internal or external resistor serves to limit current into the IC, so that higher voltage inputs do not compromise the short-term or long-term reliability of the IC.

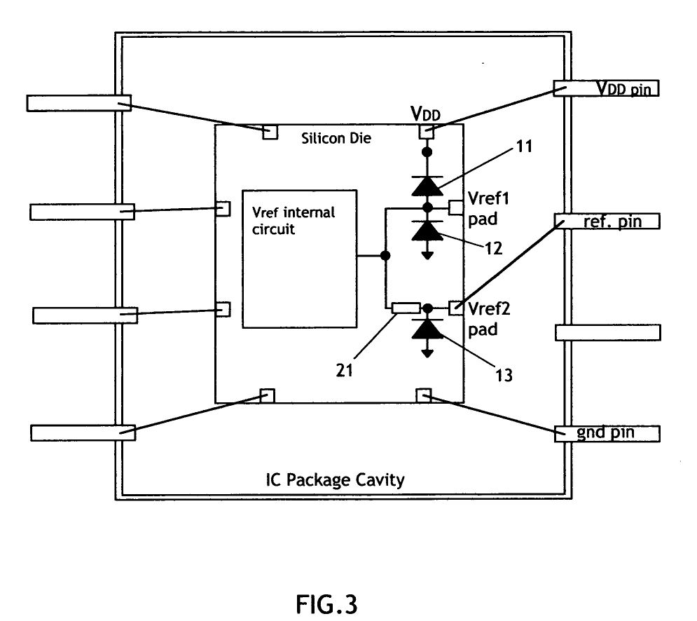

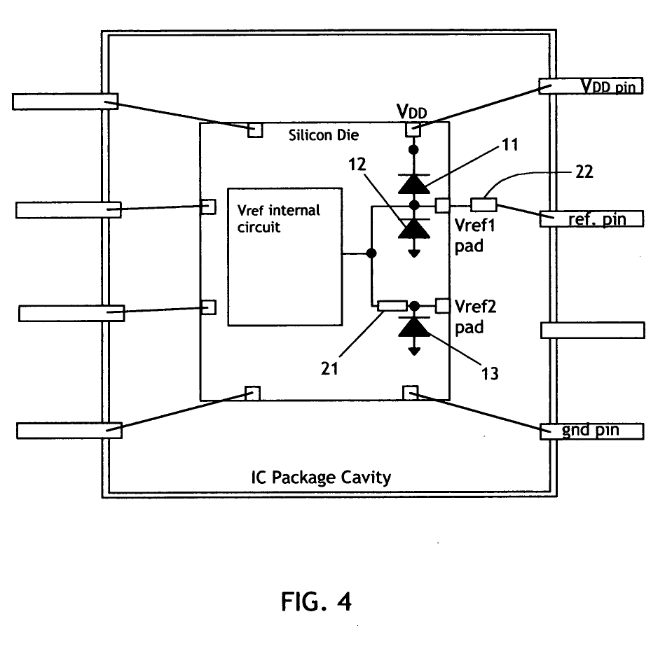

As shown in FIG. 4, in which the silicon die is shown installed in its IC package cavity, the external resistor 22 may be an in-cavity chip resistor. The use of an in-cavity resistor further enhances the dual function aspect of the invention. That is, if the die is fabricated using a dual poly-gate process, involving low and high voltage, thin and thick gate oxide, then all diodes 11, 12, and 13 will be functional, and either connection option may be selected. In this case the voltage reference pin of the IC package may be bonded to the Vref2 pad and thus connected through on-chip resistor 21 to the Vref internal circuitry, as shown in FIG. 3. Alternatively, the voltage reference pin of the IC package may be bonded to the Vref1 pad and thus connected through external resistor 22 to the Vref internal circuitry, as shown in FIG. 4. Thus either the internal resistor 21 may be used, or the external resistor 22. However, if a single poly-gate process is used for fabrication, involving low voltage, thin gate oxide, only diodes 11 and 12 will be functional, and the IC must be arranged as shown in FIG. 4, wherein external resistor 22 is connected between the Vref1 pad and the IC package reference voltage pin.

Note that for given V_{DD} voltages (1.8 volts, 2.5 volts, etc.) and for given GND (=0 volts) voltages, the reference pin is always subjected to high DC/AC voltages>>V_{DD} voltage. In both FIG. 3 and FIG. 4 cases the ESD diode 11 is expected to turn ON by design when the reference pin is subjected to high DC/AC voltages. These events are signal-type events; i.e., non-ESD events. In the general case, for high negative reference voltages, the reference pin is pulled low to<<GND=0 voltage and diodes 11-13 polarities must be oriented and connected accordingly in order to provide the desired functional isolation and turn on.

Thus it may be appreciated that the invention provides an integrated circuit that is adapted for dual use in three different ways: 1)The circuit may be powered by two different voltage sources, one being a standard low voltage source and the other being any one of a number of high voltage sources; 2) The circuit may be connected to the IC package voltage reference pin in two different ways, depending on the process used to fabricate the circuit, so that either an on-chip internal resistor or an in-package external resistor may be connected in series with the voltage reference pin to limit the voltage/current to the IC; and, 3) the ESD structures are used not only for their well-known circuit protection function, but also as a conductive path for the high voltage operating source when it is present.

The foregoing description of the preferred embodiments of the invention has been presented for purposes of illustration and description. It is not intended to be exhaustive or to limit the invention to the precise form disclosed, and many modifications and variations are possible in light of the above teaching without deviating from the spirit and the scope of the invention. The embodiment described is selected to best explain the principles of the invention and its practical application to thereby enable others skilled in the art to best utilize the invention in various embodiments and with various modifications as suited to the particular purpose contemplated. It is intended that the scope of the invention be defined by the claims appended hereto.

1. An integrated circuit, including:
a functional electronic circuit;
ESD protection connected to said electronic circuit;
a low voltage power supply for said electronic circuit;
a high voltage power supply for said electronic circuit; and,
means for selecting said low voltage power supply or said high voltage power supply to drive said electronic circuit.

2. The integrated circuit of claim 1, further including a series impedance connected between said high voltage power supply and said electronic circuit for attenuating said high voltage to a level similar to the low voltage power supply.

3. The integrated circuit of claim 2, wherein said series impedance is fabricated on the die of said integrated circuit.

4. The integrated circuit of claim 2, further including an integrated circuit package having a cavity housing said integrated circuit, wherein said series impedance is disposed externally of the die of said integrated circuit and within said cavity of said integrated circuit package.

5. The integrated circuit of claim 1, wherein said ESD protection includes a pair of diodes connected back-to-back in series between said low voltage power supply and ground, and said high voltage power supply has a first input connected between said pair of diodes, whereby one of said pair of diodes is turned on whenever said high voltage power supply is activated.

6. The integrated circuit of claim 5, wherein said means for selecting includes a voltage reference circuit fabricated on said integrated circuit, and connected to said high voltage power supply input, said voltage reference circuit including means for comparing said high voltage and low voltage power supplies.

7. The integrated circuit of claim 6, wherein said means for comparing includes an analog voltage reference level generator, and multiplex means for receiving the output of said analog voltage reference level generator and the outputs of said high voltage and low voltage power supplies and selecting whichever power supply is powered ON first to drive the integrated circuit.

8. The integrated circuit of claim 6, wherein said high voltage power supply includes a second input connected to said voltage reference circuit, and further including an internal series impedance fabricated in said integrated circuit and connected between said second input and said voltage reference circuit.

9. The integrated circuit of claim 8, further including an integrated circuit package having a cavity housing said integrated circuit, and further including an external series impedance connected between said first input and said voltage reference circuit.

10. The integrated circuit of claim 9, wherein said external series impedance is disposed externally of said integrated circuit and within said cavity housing.

11. The integrated circuit of claim 10, wherein said integrated circuit package includes a voltage reference pin, and means for selectively connecting said voltage reference pin either to said external series impedance and thence to said first input, or to said second input and thence through said internal series impedance to said voltage reference circuit.

12. The integrated circuit of claim 8, further including another ESD diode connected between said second input and ground.

13. An integrated circuit adapted to be powered by either a low voltage or a high voltage power signal, including:
means in said integrated circuit for receiving said low voltage and high voltage power signals and selecting the first of said power signals received to drive the integrated circuit;
means for connecting said high voltage power signal to said integrated circuit through a series impedance.

14. The integrated circuit of claim 13, further including ESD protection fabricated in said integrated circuit, including a pair of diodes connected in series between said low voltage power signal and ground.

15. The integrated circuit of claim 14, further including a first contact pad connected to a midpoint between said pair of diodes, and a second contact pad connected through an internal impedance to a common power supply point that is also connected to said first contact pad.

16. The integrated circuit of claim 15, further including an integrated circuit package having a cavity in which said integrated circuit is secured, said package including a voltage reference pin connectable to said integrated circuit package.

17. The integrated circuit of claim 16, further including means for connecting said voltage reference pin selectively either through an external impedance within said cavity to said first contact pad, or to said second contact pad.

18. The integrated circuit of claim 17, wherein the presence of said high voltage power signal turns on one of said pair of diodes.

19. The integrated circuit of claim 17, further including another ESD diode connected between said second contact pad and ground.

20. An integrated circuit layout on a silicon die in an IC package, including:
means for accepting either a high voltage or low voltage power source for driving the integrated circuit;
a first series impedance fabricated on-chip and connectable between the high voltage power source and the remainder of the integrated circuit;
a second series impedance external to said die and disposesd within said package and connectable between the high voltage power source and the remainder of the integrated circuit;
said IC package including a voltage reference pin;
means for selectively connecting said voltage reference pin to either said first or said second series impedance.
